(19) United States
(12) Patent Application Publication
(10) Pub. No.: US 2026/0012568 A1
(43) Pub. Date: Jan. 8, 2026

(54) DISPLAY DEVICE

(71) Applicant: Japan Display Inc., Tokyo (JP)

(72) Inventors: Takuya NISHIMOTO, Tokyo (JP); Hirofumi OHIRA, Tokyo (JP)

(73) Assignee: Japan Display Inc., Tokyo (JP)

(21) Appl. No.: 19/256,202

(22) Filed: Jul. 1, 2025

(30) Foreign Application Priority Data
Jul. 8, 2024 (JP) 2024-109619

(51) Int. Cl. H04N 13/31; H04N 13/30; H04N 13/324; H04N 13/356

(52) U.S. Cl. CPC H04N 13/31; H04N 13/324; H04N 13/356; H04N 2013/405

(57) ABSTRACT

According to an aspect, a display device includes: a display panel; a display region configured to display an image output from the display panel; a parallax barrier for enabling an image output from the display region to be visually recognized as a parallax image; and a sensor provided to overlap the parallax barrier. The display device is configured to allow a stereoscopic image to be visually recognized in a predetermined angle range including front of the display region, and no other image than the stereoscopic image to be visually recognized outside the predetermined angle range.

### CROSS-REFERENCE TO RELATED APPLICATION

This application claims the benefit of priority from Japanese Patent Application No. 2024-109619 filed on Jul. 8, 2024, the entire contents of which are incorporated herein by reference.

### BACKGROUND

### 1. Technical Field

What is disclosed herein relates to a display device.

### 2. Description of the Related Art

A display device is known in which a parallax barrier is provided between a liquid crystal display panel and a light source to block part of light projected onto the liquid crystal display panel from the light source so that a three-dimensional (3D) image can be visually recognized. Such a display device is disclosed in, for example, Japanese Patent Application Laid-open Publication No. 2008-175875.

It is possible to achieve a display device with added value by placing various sensors over a parallax barrier. When a sensor is placed over the parallax barrier, an image generated by an adjacent pixel is sometimes visible as a ghost image (hereinafter referred to as inverse image) outside a region in which a 3D image (i.e., a stereoscopic image) can be visually recognized. When an aerial operation is performed on a stereoscopic image, the visibility of an inverse visual image potentially leads to an unintended operation, which is not preferable.

For the foregoing reasons, there is a need for a display device capable of preventing or hindering an inverse visual image from being visible when an aerial operation is performed on a stereoscopic image.

### SUMMARY

According to an aspect, a display device includes: a display panel; a display region configured to display an image output from the display panel; a parallax barrier for enabling an image output from the display region to be visually recognized as a parallax image; and a sensor provided to overlap the parallax barrier. The display device is configured to allow a stereoscopic image to be visually recognized in a predetermined angle range including front of the display region, and no other image than the stereoscopic image to be visually recognized outside the predetermined angle range.

### BRIEF DESCRIPTION OF THE DRAWINGS

FIG. 1 is a schematic diagram illustrating the mechanism of a display device configured to produce stereoscopic viewing;

FIG. 2 is a schematic diagram illustrating the optical axes of light from a first panel to a plurality of viewpoints;

FIG. 3 is a diagram illustrating an exemplary configuration of a sensor;

FIG. 4 is a diagram illustrating a display device according to a first embodiment;

FIG. 5 is a schematic diagram illustrating a schematic sectional configuration of a detection system to which the display device according to the first embodiment is applied;

FIG. 6 is a block diagram illustrating an exemplary configuration of a detector of the display device according to the first embodiment;

FIG. 7 is a schematic diagram illustrating the positional relation between the position of a detection target object in a space on a detection region and each electrode;

FIG. 8 is a schematic diagram illustrating the spatial coordinate of the detection target object in the space on the detection region;

FIG. 9 is a flowchart illustrating an example of processing by a processing circuit;

FIG. 10 is a diagram illustrating a display device according to a second embodiment;

FIG. 11 is a schematic diagram illustrating a schematic sectional configuration of a display system to which the display device according to the second embodiment is applied;

FIG. 12 is a diagram for description of the concept of display according to the second embodiment; and

FIG. 13 is a diagram for description of the concept of display according to the second embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is only an example, and any modifications that can be easily conceived by those skilled in the art while maintaining the main purpose of the disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

### Mechanism of Stereoscopic Viewing

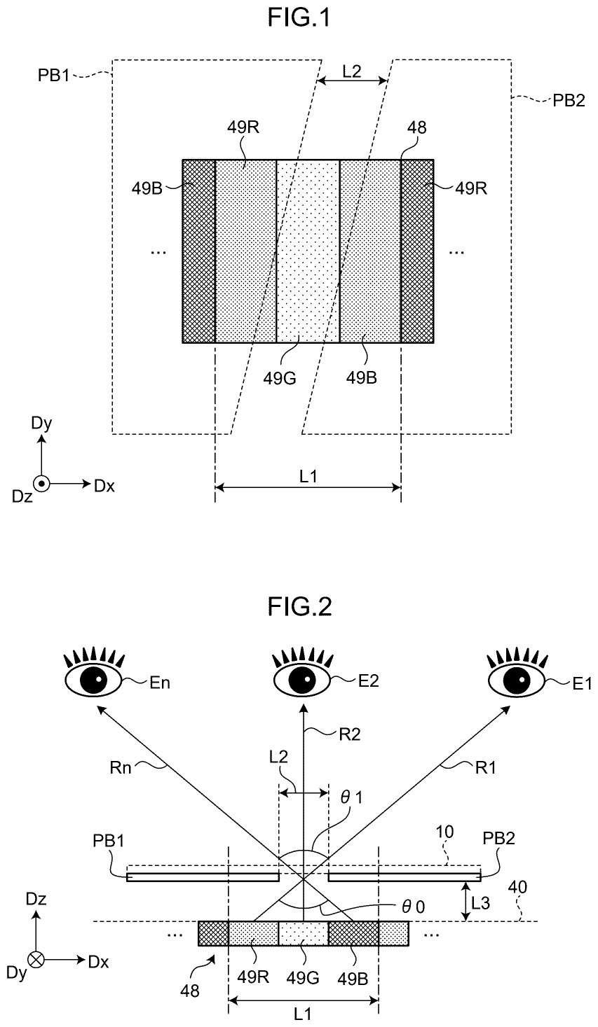

Before description of the embodiment, the mechanism of a display device configured to produce stereoscopic viewing will be described below with reference to FIGS. 1 and 2.

FIG. 1 is a schematic diagram illustrating the mechanism of a display device configured to produce stereoscopic viewing. FIG. 2 is a schematic diagram illustrating optical axes R1, R2, . . . , Rn of light from a first panel 40 to a plurality of viewpoints E1, E2, . . . , En.

A pixel 48 illustrated in FIGS. 1 and 2 includes a first sub pixel 49R, a second sub pixel 49G, and a third sub pixel 49B. Hereinafter, the term “sub pixels 49” collectively refers to the first sub pixel 49R, the second sub pixel 49G, and the third sub pixel 49B. A plurality of pixels 48 are provided on the first panel 40. The first panel 40 displays and outputs an image by luminance control of the sub pixels 49 included in each of the pixels 48. Hereinafter, two directions along an image display surface of the first panel 40 on which the pixels 48 are provided are referred to as a first direction Dx and a second direction Dy. The first direction Dx and the second direction Dy are orthogonal to each other. In addition, a direction orthogonal to the first direction Dx and the second direction Dy is referred to as a third direction Dz.

FIG. 1 exemplarily illustrates the pixels 48 that has a quadrilateral shape and are called stripe-type color pixels in which the sub pixels 49 are arranged in the order of the first sub pixel 49R, the second sub pixel 49G, and the third sub pixel 49B from one side in the first direction Dx toward the other side. However, the disposition and shapes of the sub pixels 49 included in each pixel 48 are not limited thereto but may be changed as appropriate. Furthermore, FIG. 1 and the other diagrams exemplarily illustrate the pixels 48 that achieves color display output as the first sub pixel 49R performs output in red (R), the second sub pixel 49G performs output in green (G), and the third sub pixel 49B performs output in blue (B). However, the combination and number of colors of the sub pixels 49 included in each pixel 48 are not limited thereto but may be changed as appropriate.

A parallax barrier is formed between the first panel 40 and each of viewpoints E1, E2, . . . , En of a user who recognizes an image by visually recognizing light from the first panel 40. The parallax barrier includes, for example, a light shield PB1 and a light shield PB2 illustrated in FIGS. 1 and 2, and an opening formed between the light shields PB1 and PB2. The opening is a slit that is free of the light shields and extends in a predetermined direction to transmit light. Hereinafter, the opening is also referred to as a “slit”. In FIGS. 1 and 2, the opening width of the opening in the first direction Dx is denoted by a width L2.

The light shields PB1 and PB2 block light between the first panel 40 and the viewpoints E1, E2, . . . , En. Thus, among light traveling from the first panel 40 toward the viewpoints E1, E2, . . . , En side, light having an optical axis on which the light shield PB1 or the light shield PB2 is located is blocked and not visually recognized by the user.

FIG. 2 schematically illustrates optical axes R1, R2, . . . , Rn of light traveling from the first panel 40 toward the viewpoints E1, E2, . . . , En through the opening of the parallax barrier. The optical axis R1 is the optical axis of light traveling from the first sub pixel 49R toward the viewpoint E1. The optical axis R2 is the optical axis of light traveling from the second sub pixel 49G toward the viewpoint E2. The optical axis Rn is the optical axis of light traveling from the third sub pixel 49B toward the viewpoint En. Two of the viewpoints E1, E2, . . . , En are viewpoints of the two eyes of the user (human). In this manner, stereoscopic viewing is achieved with the optical axes R1, R2, . . . , Rn of light traveling from the sub pixels 49 toward the different viewpoints E1, E2, . . . , En, respectively. Moreover, different stereoscopic images can be visually recognized from different viewpoints as the user changes its relative position to the first panel 40 and the parallax barrier.

The number (n) of optical axes R1, R2, . . . , Rn is an arbitrary natural number. As the number n is larger, stereoscopic viewing is possible at a larger number of viewpoints E1, E2, . . . , En.

An incident angle range θ0 of light entering the opening of the parallax barrier and an emission angle range θ1 of light that can travel from the first panel 40 toward the viewpoints E1, E2, . . . , En through the opening of the parallax barrier are determined in accordance with the width L2 and an interval L3 between the first panel 40 and the parallax barrier. An emission area L1 of the first panel 40 in which light can be emitted through one opening of the parallax barrier is determined in accordance with the emission angle range θ1. The emission angle range θ1 depends on the design (such as pixel size) of the panel and is preferably 10° to 160° inclusive approximately. If the emission angle range θ1 is smaller than 10°, a range in which stereoscopic viewing with both eyes is allowed becomes significantly narrow, which is not preferable. If the emission angle range θ1 is larger than 160°, a distance G between a sensor 10 and a display panel 200, which is necessary for visually recognizing a stereoscopic image, needs to be significantly reduced and such a configuration is highly likely to be impractical. Furthermore, coordinate variation at a pixel surface portion decreases, resulting in significant decrease in light beam density, which is not preferable. The emission area L1 has a width in the first direction Dx. The width of the emission area L1 in the first direction Dx is larger than the width L2.

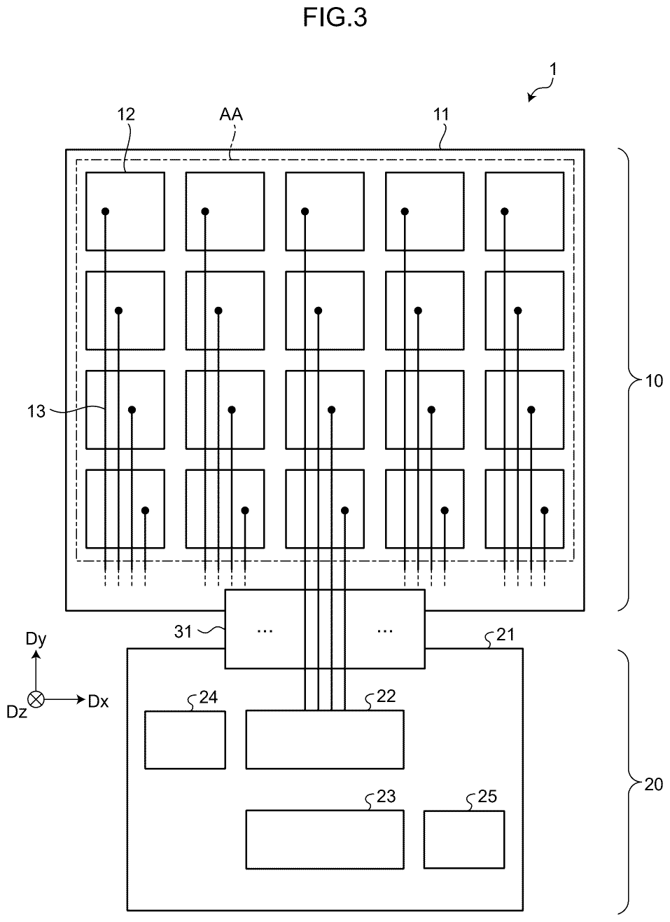

A sensor 10 is provided on the third direction Dz side of the parallax barrier including the light shields PB1 and PB2. FIG. 3 is a diagram illustrating an exemplary configuration of the sensor 10. The sensor 10 includes a sensor substrate 11, a plurality of electrodes 12 provided in a detection region AA of the sensor substrate 11, and wirings 13 extending from the respective electrodes 12. The sensor 10 is coupled to a detector 20. The detector 20 includes a control substrate 21, a detection circuit 22, a processing circuit 23, a power circuit 24, and an interface circuit 25.

The detection region AA of the sensor substrate 11 is a region provided with the electrodes 12 arranged in a matrix of rows and columns in the Dx direction (first direction) and the Dy direction (second direction). The sensor substrate 11 is, for example, a glass substrate or a light-transmitting flexible printed circuit board (FPC).

A display device according to the present embodiment has a function to detect the position of a detection target object in a space on the detection region AA of the sensor substrate 11 and calculate the coordinates of the detection target object. In the present disclosure, the Dx direction (first direction) and the Dy direction (second direction) are orthogonal to each other in the detection region AA. Moreover, in the present disclosure, a direction orthogonal to the Dx direction (first direction) and the Dy direction (second direction) is referred to as the Dz direction (third direction).

Although 5×4 (=20) electrodes 12 with five electrodes 12 in the Dx direction and four electrodes 12 in the Dy direction are provided in the example illustrated in FIG. 3, the number of electrodes 12 provided in the detection region AA of the sensor substrate 11 is not limited thereto.

The control substrate 21 is electrically coupled to the sensor substrate 11 through a wiring substrate 31. The wiring substrate 31 is, for example, a flexible printed circuit board. Each electrode 12 in the sensor 10 is coupled to the detection circuit 22 of the detector 20 through the wiring substrate 31.

The control substrate 21 is provided with the detection circuit 22, the processing circuit 23, the power circuit 24, and the interface circuit 25. The control substrate 21 is, for example, a rigid substrate.

The detection circuit 22 generates a detected value of each electrode 12 based on a detection signal of the electrode 12, which is output from the sensor substrate 11. The detection circuit 22 is, for example, an analog front end (AFE) IC.

The processing circuit 23 generates a spatial coordinate indicating the position of a detection target object (for example, an operator's finger) in a space on the detection region AA based on the detected value of each electrode 12, which is output from the detection circuit 22. The processing circuit 23 may be, for example, a programmable logic device (PLD) such as a field programmable gate array (FPGA) or may be a micro control unit (MCU).

The power circuit 24 is a circuit configured to supply power to the detection circuit 22 and the processing circuit 23.

The interface circuit 25 is, for example, a universal serial bus (USB) controller IC and is a circuit configured to control communication between the processing circuit 23 and a host controller (not illustrated) of a host device on which a detection system is mounted.

### FIRST EMBODIMENT

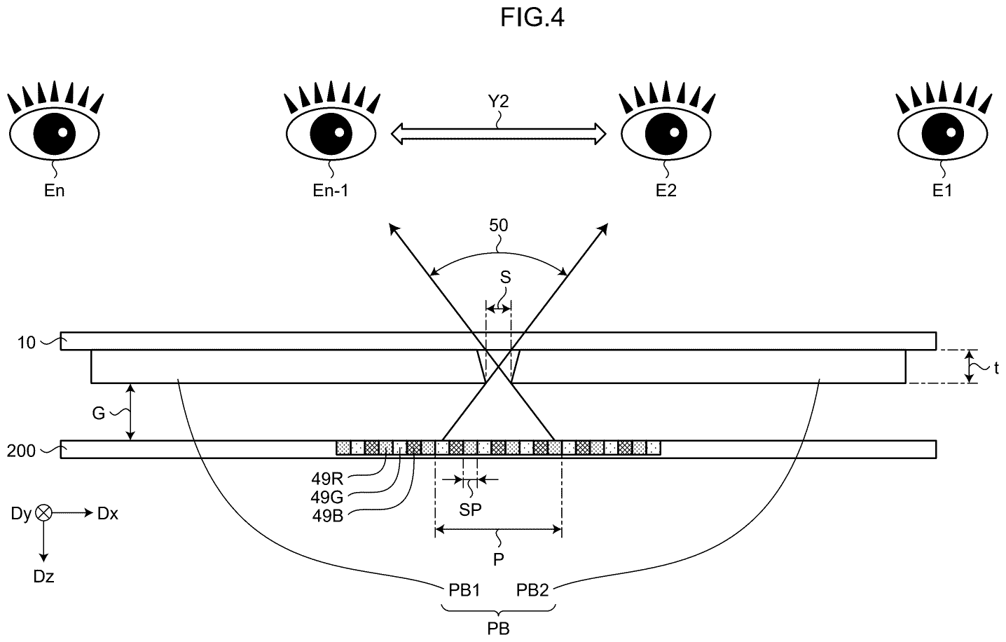

In the display device including the sensor 10 described above, an inverse visual image is potentially visible outside a region (visible region) in which a stereoscopic image can be visually recognized. A configuration for preventing or hindering an inverse visual image from being visible will be described below with reference to FIG. 4. FIG. 4 is a diagram illustrating a display device according to a first embodiment. FIG. 4 illustrates a configuration for preventing or hindering an inverse visual image from being visible. In FIG. 4, a parallax barrier PB including the light shields PB1 and PB2 is provided apart from the display panel 200 by the distance G in the Dz direction. In addition, the sensor 10 is provided so as to overlap the parallax barrier. In FIG. 4, the number P of pixels used at one opening of the parallax barrier PB among pixels included in the display panel 200 is an integral multiple of the number of the sub pixels SP.

A thickness t of the parallax barrier, in other words, the thickness t of the light shields PB1 and PB2 is determined so that an inverse visual image is invisible. The thickness t is a thickness in the direction from the display panel 200 toward the sensor 10. The thickness t is determined in accordance with Expression (1) below, for example.

t≥(2×S×G)/(P−S) (1)

In Expression (1), “S” is the opening width of the parallax barrier, “G” is the distance between the parallax barrier and the display panel 200, and “P” is the number of pixels used at one opening of the parallax barrier PB among pixels included in the display panel 200. By determining the thickness t in accordance with Expression (1), effects as follows are obtained. Specifically, in the configuration illustrated in FIG. 4, an angle range 50 is a region including the front of a display region. As the viewpoint moves as illustrated with arrow Y2 in the angle range 50, a stereoscopic image can be visually recognized at the viewpoints E2 to En−1 in the angle range 50. However, at the viewpoints E1 and En outside the angle range 50, no stereoscopic image can be visually recognized, and no other image than the stereoscopic image, in other words, no inverse visual image, can be visually recognized.

Expression (1) above is merely exemplary and even if the thickness is not a value different from that of Expression (1) due to influence of the barrier material, a tapered shape of a slit portion, and the like, there is no problem as long as an inverse visual image cannot be visually recognized by virtue of the barrier thickness.

In the present example, as illustrated in FIG. 4, the opening width of the parallax barrier PB, which is provided between the light shields PB1 and PB2, has a tapered shape in which the width on the sensor 10 side is larger than the width on the display panel 200 side. The width on the display panel 200 side is used as the opening width S in Expression (1). The tapered shape differs depending on a barrier formation method and an orientation when in use, in other words, whether a barrier film is used upward or downward, and the like. Thus, a tapered shape opposite to that illustrated in FIG. 4 may be adopted in which the width on the sensor 10 side is smaller than the width on the display panel 200 side. In any case, the opening width S of the parallax barrier PB is determined by a thickness position where the width is smallest.

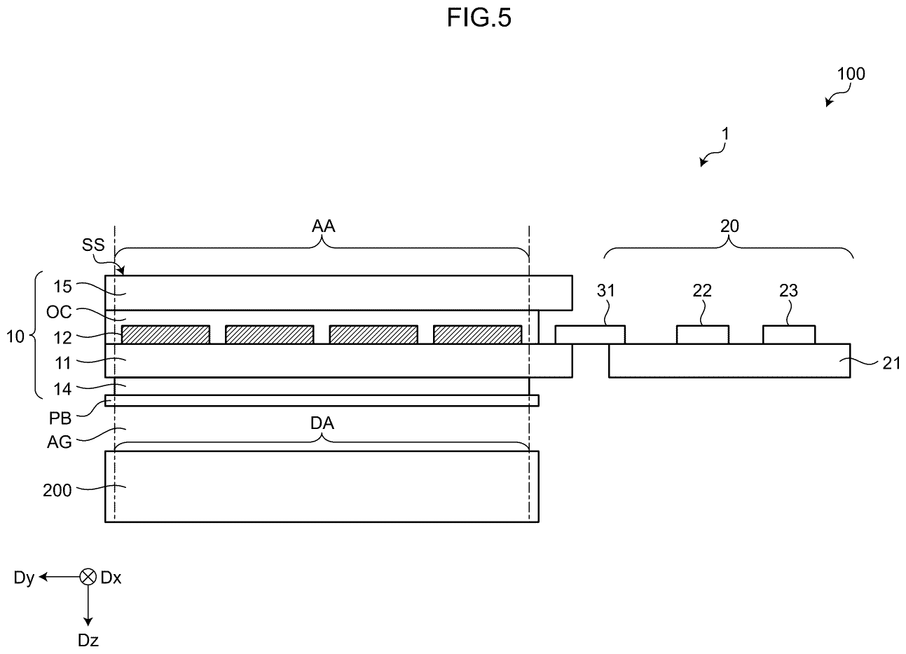

FIG. 5 is a schematic diagram illustrating a schematic sectional configuration of a display system to which the display device according to the first embodiment is applied.

This display system 100 includes the display device 1 and a display panel 200. The display panel 200 corresponds to a display region configured to display an image. The display panel 200 is disposed facing the sensor 10 of the display device 1 with an air gap AG therebetween. The sensor 10 of the display device 1 is disposed such that the detection region AA of the sensor 10 and a display region DA of the display panel 200 are arranged in the Dz direction (third direction) to overlap each other in a plan view. The display panel 200 is, for example, a liquid crystal display (LCD). The display panel 200 may be, for example, an organic EL display (organic light emitting diode or OLED), an inorganic EL display (micro LED or mini LED), or a transparent display that displays an image on a light-transmitting display surface.

The sensor 10 includes the sensor substrate 11, the electrodes 12, a shield 14, and a cover glass 15. The sensor 10 is configured such that a parallax barrier PB, the shield 14, the sensor substrate 11, the electrodes 12, and the cover glass 15 are stacked in the stated order from the display panel 200 side. Hereinafter, the upper surface of the cover glass 15 provided at the uppermost layer is also referred to as a “detection surface SS”. The detection surface SS is not limited to the upper surface of the cover glass 15. In the present disclosure, the detection surface SS is a reference surface for defining the distance to a detection target object in the Dz direction (third direction) and may be, for example, the upper surface of the electrodes 12.

The shield 14 is provided on a first surface of the sensor substrate 11 on the display panel 200 side. The electrodes 12 is provided on a second surface of the sensor substrate 11 on the back side of the first surface. Each electrode 12 has, for example, a mesh structure formed of fine metal lines. Since the mesh structure is formed of fine metal lines, the fine metal lines are made visually inconspicuous while allowing light from the display panel 200 to transmit through spaces between the fine metal lines.

The cover glass 15 is provided on the second surface of the sensor substrate 11 with a bonding layer OC interposed therebetween. A light-transmitting bonding agent is desirably employed as the bonding layer OC. The bonding layer OC may be formed of a light-transmitting film having double-sided adhesiveness, such as an optical clear adhesive (OCA). The parallax barrier PB for implementing the light shields PB1 and PB2 (refer to FIG. 2) is provided on the display panel 200 side of the shield 14. The parallax barrier PB is provided so as to overlap the display panel 200 with the air gap AG interposed therebetween. The parallax barrier PB enables an image output from the display region to be visually recognized as a parallax image.

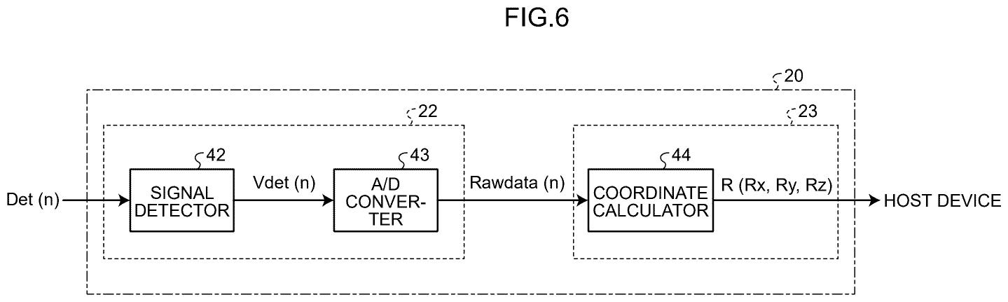

FIG. 6 is a block diagram illustrating an exemplary configuration of the detector of the display device according to the first embodiment. In the present disclosure, the detector 20 calculates the coordinate of a detection target object in the space on the detection region AA.

As illustrated in FIG. 6, the detector 20 includes a signal detector 42, an analog-to-digital (A/D) converter 43, and a coordinate calculator 44. The signal detector 42 and the A/D converter 43 are included in the detection circuit 22. The coordinate calculator 44 is included in the processing circuit 23.

The signal detector 42 generates an output value Rawdata (n) of each electrode 12 based on a detection signal Det (n) (n is a natural number of 1 to N, where N is the number of electrodes in the detection region AA) of the electrode 12, which is output from the sensor substrate 11. The A/D converter 43 samples the output value of each electrode 12 to convert the output value of the electrode 12 into a digital signal.

The coordinate calculator 44 calculates the spatial coordinates R (Rx, Ry, Rz) of a position where the detection target object exists based on the output value Rawdata (n) of each electrode 12.

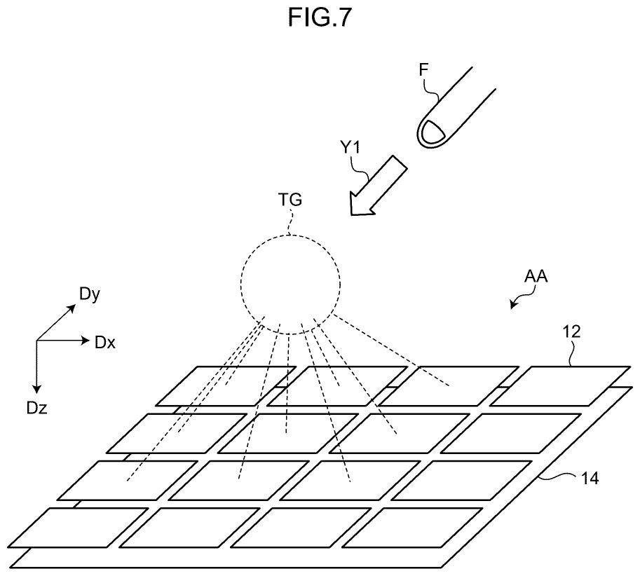

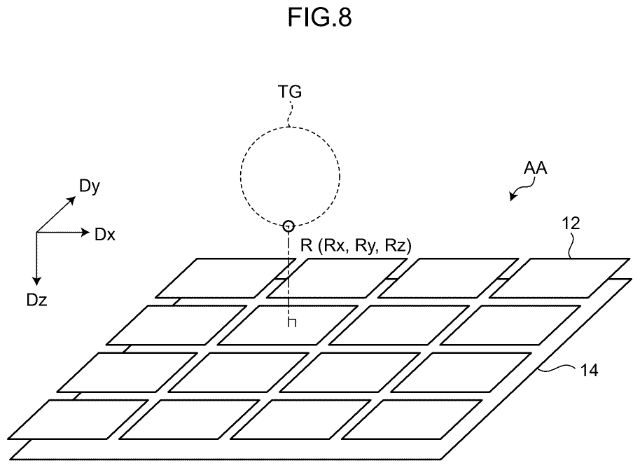

FIG. 7 is a schematic diagram illustrating the positional relation between the position of the detection target object in the space on the detection region and each electrode. FIG. 8 is a schematic diagram illustrating the spatial coordinate of the detection target object in the space on the detection region. FIGS. 7 and 8 illustrate an example in which a stereoscopic image target TG exists in the space on the detection region AA.

As illustrated in FIG. 7, in the present example, the 12 electrodes 12 are provided in the detection region AA.

The target TG is, for example, a 3D image of a press button. When a detection target object F such as an operator's finger approaches the target TG as illustrated with arrow Y1 to operate the press button, a capacitance corresponding to the distance between the detection target object F existing in the space on the detection region AA and each electrode 12 is generated at the electrode 12 in the detection region AA, and the output value Rawdata (n) corresponding to the capacitance is acquired by the detection circuit 22. In this manner, the sensor 10 outputs the value of a capacitance generated between each electrode 12 and the detection target object F.

The processing circuit 23 extracts the spatial coordinates R (Rx, Ry, Rz) indicating the position of the detection target object F in the space on the detection region AA illustrated in FIG. 8 by using the output value Rawdata (n) of each electrode 12, which is generated by the detection circuit 22.

In the present disclosure, the spatial coordinates R (Rx, Ry, Rz) correspond to the position of the detection target object F existing in the space on the detection surface SS. The spatial coordinates R (Rx, Ry, Rz) include X-directional first data Rx corresponding to a position in the Dx direction (first direction) on the detection region AA, Y-directional second data Ry corresponding to a position in the Dy direction (second direction) on the detection region AA, and Z-directional third data Rz corresponding to a position in the Dz direction (third direction) orthogonal to the Dx direction (first direction) and the Dy direction (second direction).

The processing circuit 23 outputs the coordinate calculated by the coordinate calculator 44. The coordinates calculated by the coordinate calculator 44 are transmitted to the host device through the interface circuit 25. The host device performs control in accordance with the coordinates transmitted from the processing circuit 23. Specifically, the host device executes processing in accordance with selection of the target TG such as image display of the press button. The present disclosure is not limited by the processing in the host device.

### Example of Processing by Processing Circuit

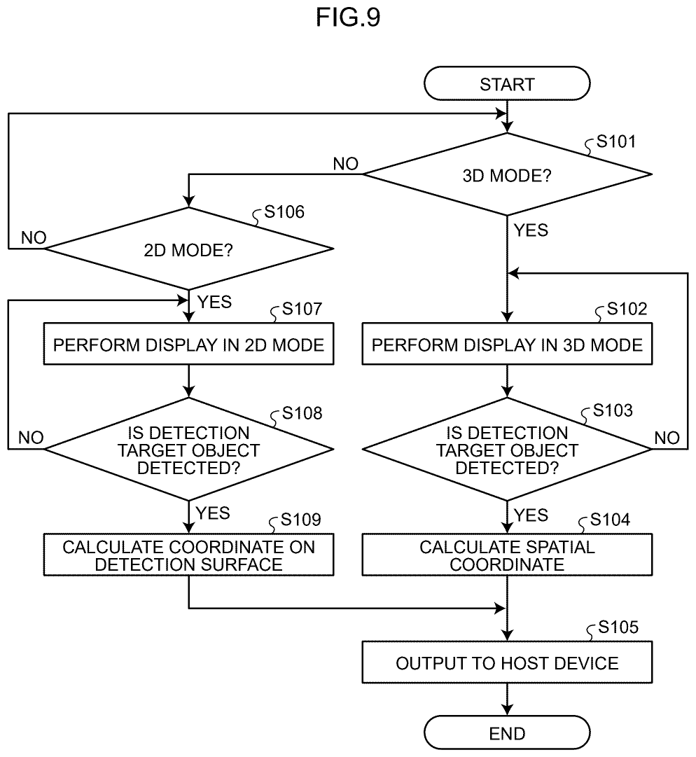

FIG. 9 is a flowchart illustrating an example of processing by the processing circuit 23. In the present example, different coordinates are calculated depending on whether an operation mode is a two-dimensional (2D) mode or a 3D mode. The 2D mode is an operation mode for displaying a 2D image. The 3D mode is an operation mode for displaying a 3D image.

In FIG. 9, the processing circuit 23 determines whether the current operation mode is the 3D mode (step S101). If the current operation mode is determined to be the 3D mode in the determination at step S101 (Yes at step S101), the process transitions to step S102 to perform display in the 3D mode (step S102).

During the display in the 3D mode, it is determined whether a detection target object such as a finger is detected (step S103). If a detection target object is determined to be detected in the determination at step S103 (Yes at step S103), the process transitions to step S104 to calculate the spatial coordinates of the detection target object (step S104). The calculated coordinates are output to the host device (step S105).

If it is determined that no detection target object is detected in the determination at step S103 (No at step S103), the display in the 3D mode is continued (step S102) and the determination of whether a detection target object is detected is continued (step S103).

If the current operation mode is not determined to be the 3D mode in the determination at step S101 (No at step S101), it is determined whether the current operation mode is the 2D mode (step S106). If the current operation mode is determined to be the 2D mode in the determination at step S106 (Yes at step S106), the process transitions to step S107 to perform display in the 2D mode (step S107).

During the display in the 2D mode, it is determined whether a detection target object such as a finger is detected (step S108). If a detection target object is determined to be detected in the determination at step S108 (Yes at step S108), its coordinates on the detection surface are calculated (step S109). The calculated coordinates are output to the host device (step S105).

If no detection target object is determined to be detected in the determination at step S108 (No at step S108), the display in the 2D mode is continued (step S107) and the determination of whether a detection target object is detected is continued (step S108).

If the current operation mode is not determined to be the 2D mode in the determination at step S106 (No at step S106), the process returns to step S101 to determine the current operation mode (step S101).

As described above, by performing processing in accordance with the operation mode, the processing circuit 23 can calculate coordinates in accordance with the current operation mode and output the detected coordinates to the host device. For example, during display of the 3D mode, since the spatial coordinates in a normal stereoscopic image are known, the host device can determine detection of a detection target object at a position other than the spatial coordinates in the normal stereoscopic image. Thus, it is possible to reflect operation of the detection target object in a 3D display region onto control while ignoring operation of the detection target object in the other region. In this manner, the host device can perform control in accordance with the coordinates.

### Second Embodiment

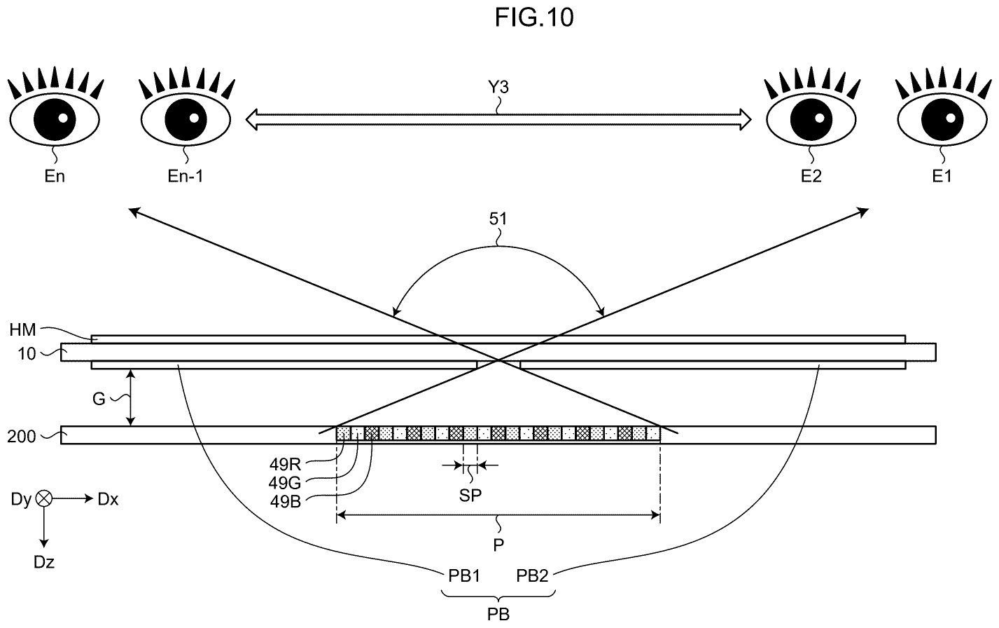

FIG. 10 is a diagram illustrating a display device according to a second embodiment. FIG. 10 illustrates a region in which an inverse visual image is visible and a configuration for preventing or hindering the inverse visual image from being visible. The display device illustrated in FIG. 10 has a configuration in which a semi-reflective mirror HM is disposed on the outermost surface of the sensor 10. In this point, the configuration in the second embodiment is different from that in the first embodiment. When a backlight of the display panel 200 is turned on, the semi-reflective mirror HM transmits light from the display panel 200 while reducing its light quantity. The semi-reflective mirror HM reflects light from the front when the backlight of the display panel 200 is not turned on.

In the second embodiment, Expression (1) is not used to determine the thickness of the parallax barrier. In the second embodiment, the thickness of the parallax barrier is smaller than in the first embodiment. Accordingly, an angle range 51 in the second embodiment is larger than the angle range 50 (refer to FIG. 4) in the first embodiment. As the viewpoint moves as illustrated with arrow Y3 in the configuration illustrated in FIG. 10, a stereoscopic image can be visually recognized at the viewpoints E1 to En in the angle range 51. However, at viewpoints outside the angle range 51, no stereoscopic image can be visually recognized, and no other image than the stereoscopic image, in other words, no inverse visual image, can be visually recognized since the light quantity can be reduced through the semi-reflective mirror HM.

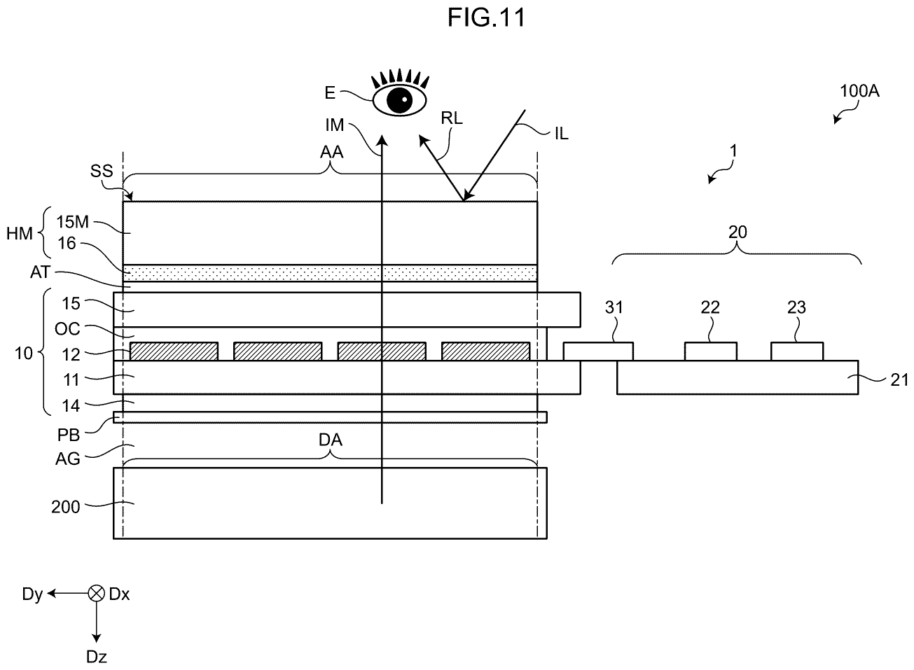

FIG. 11 is a schematic diagram illustrating a schematic sectional configuration of a display system 100A to which the display device according to the second embodiment is applied. As illustrated in FIG. 11, in the configuration of the second embodiment, the semi-reflective mirror HM is disposed on the cover glass 15 of the sensor 10. The semi-reflective mirror HM is provided at a position closest to a viewer. The parallax barrier PB is provided at a position sandwiched between the display panel 200 and the semi-reflective mirror HM. The semi-reflective mirror HM is fixed to the cover glass 15 through a bonding layer AT. The bonding layer AT is, for example, a light-transmitting bonding agent called an optical clear adhesive (OCA). The bonding layer AT may be, for example, another transparent bonding agent such as an optical clear resin (OCR) or an air gap. The bonding layer AT may be a light-transmitting film having double-sided adhesiveness. The semi-reflective mirror HM includes a light-transmitting base member 15M and a mirror layer 16. The mirror layer 16 is, for example, a dielectric multilayered film in which a high-refractive-index transparent dielectric film and a low-refractive-index transparent dielectric film are stacked. The mirror layer 16 is not limited to a dielectric multilayered film but may be a mirror made of a metal with high reflectance, such as aluminum or molybdenum. The base member 15M is, for example, a glass substrate. The base member 15M may be made of a light-transmitting resin.

In the display system 100A according to the second embodiment, when the display panel 200 displays an image and emission light IM passes through the sensor 10 and the semi-reflective mirror HM, the emission light IM of the displayed image can reach an eye E of the viewer. When the emission light IM from the display panel 200 is weaker than incident light IL incident on the semi-reflective mirror HM from outside or when there is no emission light IM from the display panel 200, the incident light IL is reflected by the semi-reflective mirror HM and visually recognized by the viewer as reflected light RL.

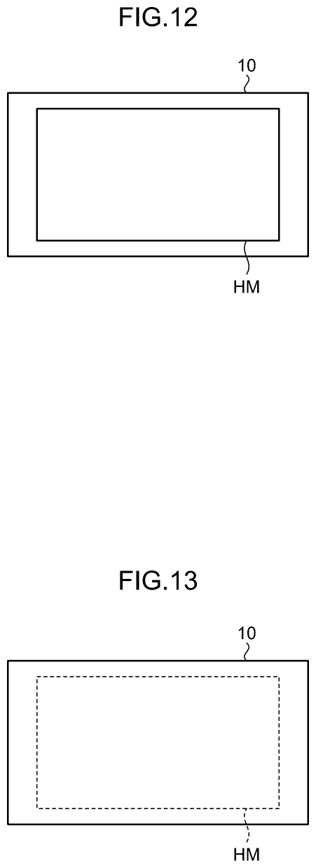

FIGS. 12 and 13 are diagrams for description of the concept of display according to the second embodiment. FIG. 12 illustrates a state when the backlight of the display panel 200 is turned on. In FIG. 12, when the light quantity of the backlight of the display panel 200 is sufficiently large, the region of the semi-reflective mirror HM in a region 201 in which the parallax barrier PB is provided is bright and a stereoscopic image can be visually recognized. In this state, the light quantity is insufficient in regions other than the region of the semi-reflective mirror HM, and accordingly, an inverse visual image cannot be visually recognized or is hardly visible.

FIG. 13 illustrates a state when the backlight of the display panel 200 is not turned on. In FIG. 13, the region of the semi-reflective mirror HM acts as a mirror since the backlight of the display panel 200 is not turned on. Accordingly, a stereoscopic image cannot be visually recognized in the region of the semi-reflective mirror HM. In addition, an inverse visual image cannot be visually recognized in the region of the semi-reflective mirror HM.

When The backlight of the display panel 200 is replaced with a backlight having directionality or combined with collimated light, the difference in brightness between a stereoscopic image and an inverse visual image becomes more pronounced. In this manner, display in the bright visible region is more visible than with reflection, whereas display in the dark inverse region is less visible due to the mirror effect. As a result, the inverse visual image becomes less noticeable.

What is claimed is:

1. A display device comprising:
a display panel;
a display region configured to display an image output from the display panel;
a parallax barrier for enabling an image output from the display region to be visually recognized as a parallax image; and
a sensor provided to overlap the parallax barrier, wherein
the display device is configured to allow a stereoscopic image to be visually recognized in a predetermined angle range including front of the display region, and no other image than the stereoscopic image to be visually recognized outside the predetermined angle range.

2. The display device according to claim 1, wherein the predetermined angle range is a range of 10° to 160° inclusive and includes a front of the display panel.

3. The display device according to claim 1, wherein
the parallax barrier has a thickness t in a direction from the display panel to the sensor, and
the thickness t of the parallax barrier is given by
t≥(2×S×G)/(P−S)
where S is an opening width of the parallax barrier, G is a distance between the parallax barrier and the display panel, and P is the number of pixels used at one opening of the parallax barrier among pixels included in the display panel.

4. The display device according to claim 1, further comprising a semi-reflective mirror provided on the sensor, wherein
the parallax barrier is provided between the display panel and the semi-reflective mirror,
the stereoscopic image is allowed to be visually recognized when the display panel outputs an image, and
the parallax barrier and the sensor are allowed to be visually recognized due to a mirror surface of the semi-reflective mirror when the display panel does not output an image.

5. The display device according to claim 1, wherein
the sensor includes a plurality of electrodes, and
a value of a capacitance generated between each of the electrodes and a detection target object is detected.

6. The display device according to claim 1, wherein the sensor detects a detection target object in a region in which the stereoscopic image is visually recognized in an angle range of a region that includes the front of the display region and in which a stereoscopic image is visually recognized.
